(19) United States
(12) Patent Application Publication
(10) Pub. No.: US 2004/0022479 A1
(43) Pub. Date: Feb. 5, 2004

(54) Normally latched MEMS engagement mechanism

(76) Inventors: Michael E. Hamerly, Vadnais Heights, MN (US); Melinda K. Kovach, Woodbury, MN (US)

Correspondence Address: 3M INNOVATIVE PROPERTIES COMPANY, PO BOX 33427, ST. PAUL, MN, 55133-3427, US

(21) Appl. No.: 10/208,534

(22) Filed: Jul. 30, 2002

(51) Int. Cl. G02B 6/35; G02B 7/182

(52) U.S. Cl. 385/18; 359/872

(57) ABSTRACT

A normally latched MEMS device and a method of making a normally latched MEMS device. The MEMS device includes a first discrete MEMS structure with an operational surface having an outer boundary. A second discrete MEMS structure in a neutral position includes an operational surface engaged with the first discrete MEMS structure. An actuator is provided to displace the second discrete MEMS structure from the engaged position to a disengaged position outside of the outer boundary.

### FIELD OF THE INVENTION

The present invention relates to a normally latched MEMS device, and in particular, to a first discrete MEMS structure engaged with a second discrete MEMS structure without the use of actuators or other external force generating devices.

### BACKGROUND OF THE INVENTION

Fabricating complex micro-electro-mechanical systems (MEMS) and micro-optical-electro-mechanical systems (MOEMS) devices represents a significant advance in micro-mechanical device technology. Presently, micrometer-sized analogs of many macro-scale devices have been made, such as, for example, hinges, linear and rotary rack drives, shutters, lenses, mirrors, switches, polarizing devices, actuators, and a variety of mechanical linkage systems. These devices can be fabricated, for example, using Multi-User MEMS processing (MUMPs), available from Cronos Integrated Microsystems (a JDS Uniphase Company), located at Research Triangle Park, N.C. Applications of MEMS and MOEMS devices include, for example, data storage devices, laser scanners, printer heads, magnetic heads, micro-spectrometers, accelerometers, scanning-probe microscopes, near-field optical microscopes, optical scanners, optical modulators, micro-lenses, optical switches, and micro-robotics.

Various types of actuators, including electrostatic, piezoelectric, thermal, and magnetic can be formed using MEMS or MUMPS processing and/or coupled to MEMS devices. One such actuator is described by Cowan et al. in “Vertical Thermal Actuator for Micro-Opto-Electro-Mechanical Systems”, v. 3226, SPIE, pp. 137-146 (1997). These actuators can be used to provide the motive force for MEMS drives and linkage mechanisms.

MEMS drive and linkage mechanisms typically include two discrete structures that move relative to each other. The MUMPS design rules, however, require the two discrete structures to be fabricated a minimum distance apart, in a disengaged position. If the device is designed with the two structures closer together than the design rules allow, the two structures will most likely be fabricated as a single piece and relative motion between the two structures will not be possible.

Power is typically supplied to move the two discrete structures from the disengaged position (as fabricated) into the engaged position. To maintain the engaged configuration, power must be continually applied. It may not be practical, however, to supply power for long periods of time, either due to the amount of power or the consistency of power required. Additionally, absent another feature on the MEMS device, the two discrete structures are free to move relative to each other during fabrication and handling, increasing the risk of damage to the MEMS device.

FIG. 1 illustrates a conventional MEMS rack drive mechanism in which drive 20 moves relative to rack 22. Hold 24 operates to prevent unwanted movement of the rack 22 during engagement and disengagement of the drive 20 with the rack 22. FIG. 1 illustrates the drive 20 and the hold 24 in an unpowered or neutral position. In the neutral position, the drive 20 is separated from the rack 22 by a small gap 26 that is created during fabrication using the MUMPS process. Similarly, the hold 24 is separated from the rack 22 by gap 28.

In operation, power is applied to actuator 30, causing it to move in the direction 32 and pushing the drive 20 into engagement with the rack 22. Power is then applied to actuator 31 on the drive 20, causing it to move in the direction 34 (or the opposite of 34). Movement of the drive 20 causes the rack 22 to also move in the direction 34. Power is then applied to the hold 24 causing it to move in the direction 36 and to retain the rack 22 in its current location. Power is then removed from the actuators 30, 31, causing the drive 20 to move in both the direction 40 and the direction 42 (or the opposite of 42, back to its neutral, disengaged position. Power is again applied to the actuator 30, causing the drive 20 to engage with the rack 22. Power is removed from the hold 24, causing it to move in the direction 44, back to its neutral position.

### BRIEF SUMMARY OF THE INVENTION

The present invention is directed to a normally latched MEMS device. The MEMS device includes a first discrete MEMS structure with an operational surface having an outer boundary. A second discrete MEMS structure in a neutral position includes an operational surface engaged with the first discrete MEMS structure. An actuator is provided to displace the second discrete MEMS structure from the engaged position to a disengaged position outside of the outer boundary.

The normally latched MEMS device typically includes a second actuator adapted to displace the second discrete MEMS structure while it is engaged with the first discrete MEMS structure. Alternatively, the second actuator is adapted to displace the first discrete MEMS structure while it is engaged with the second discrete MEMS structure. In one embodiment, the first discrete MEMS structure is a rotary or a linear rack.

In one embodiment, the operational surface on the first discrete MEMS structure includes a recess sized to receive the operational surface of the second discrete MEMS structure when the second discrete MEMS structure is in the neutral position as fabricated. In another embodiment, the operational surface of the second discrete MEMS device lies within an edge of the operational surface of the first discrete MEMS device when in the neutral position.

In some embodiments, the second discrete MEMS structure generates a biasing force against the first discrete MEMS structure when in the engaged configuration. In another embodiment, the second discrete MEMS structure is displaced from the neutral position to an operational position when engaged with a portion of the operational surface on the first discrete MEMS structure. In some, but not all embodiments, the neutral position is the same as the operational position. The second discrete MEMS structure typically generates a biasing force against the first discrete MEMS structure when in the operational position.

The normally latched MEMS device may include at least one optical device. The optical device can be one of a reflector, a lens, a polarizer, a wave guide, a shutter, an occluding structure, or a variety of other structures.

The present invention is also directed to a method of making a normally latched MEMS device. The method includes preparing a first discrete MEMS structure with an operational surface having an outer boundary; preparing a second discrete MEMS structure in a neutral position having an operational surface engaged with the first discrete MEMS structure; and preparing an actuator adapted to displace the second discrete MEMS structure from the engaged position to a disengaged position outside of the outer boundary.

The method optionally includes preparing a second actuator adapted to displace either the first or the second discrete MEMS structure while it is engaged with the other discrete MEMS structure.

The present invention is also directed to an optical communication system including at least one optical device.

### BRIEF DESCRIPTION OF THE SEVERAL VIEWS OF THE DRAWING

Further features of the invention will become more apparent from the following detailed description of specific embodiments thereof when read in conjunction with the accompany drawings.

FIG. 1 is a top view of a prior art MEMS rack drive mechanism.

FIG. 2 is a top view of a normally latched MEMS linear rack drive in the neutral position in accordance with the present invention.

FIG. 3 is a top view of the normally latched MEMS linear rack drive of FIG. 2 in a disengaged configuration.

FIG. 4 is a top view of the normally latched MEMS linear rack drive of FIG. 2 in the engaged position.

FIG. 5 is a top view of a normally latched MEMS hold device in accordance with the present invention.

FIG. 6 is top view of a normally latched MEMS rotary rack drive in accordance with the present invention.

FIG. 7 is a top view of an exemplary rotating micro-mirror using a normally latched drive in accordance with the present invention.

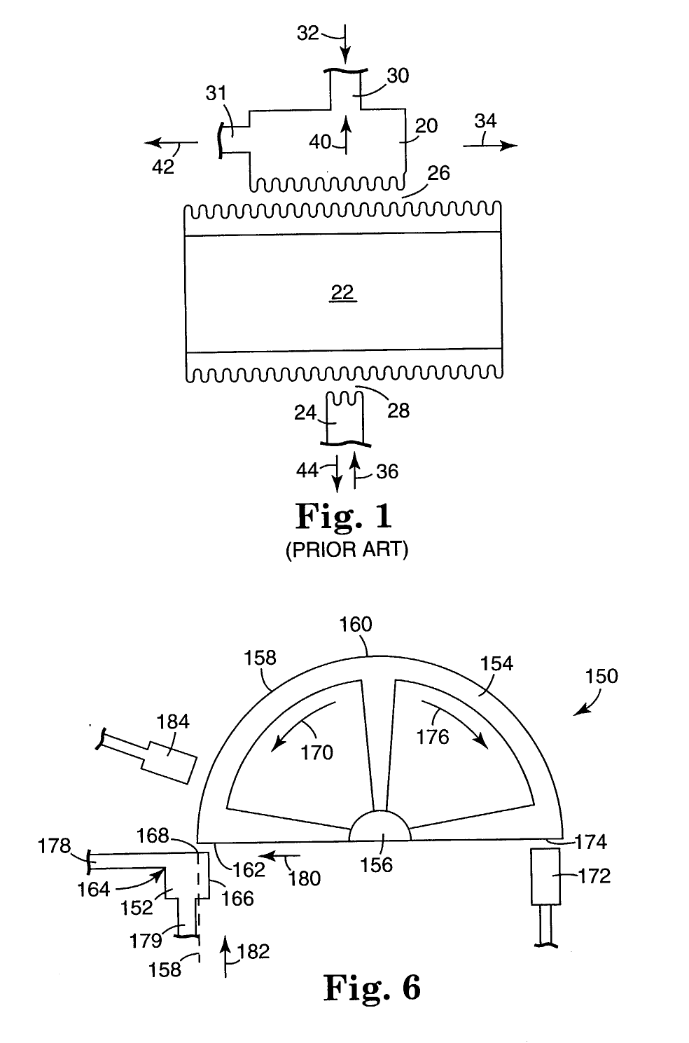

### DETAILED DESCRIPTION OF THE INVENTION

The present invention relates generally to a MEMS device for engaging and disengaging two or more discrete moving MEMS structures where the MEMS structures are fabricated in an engaged position without the use of an external force generating device. As used herein, “MEMS device” refers to micrometer-sized mechanical, opto-mechanical, electromechanical, and/or opto-electro-mechanical devices. Various technologies for fabricating micro-mechanical devices are available using the Multi-User MEMS Processes (MUMPs), available from Cronos Integrated Microsystems, located at Research Triangle Park, N.C. One description of the assembly procedure is described in “MUMPs Design Handbook”, revision 5.0 (2000), available from Cronos Integrated Microsystems.

Polysilicon surface micromachining adapts planar fabrication process steps known to the integrated circuit (IC) industry to manufacture MEMS devices. The standard building-block processes for polysilicon surface micromachining are deposition and photolithographic patterning of alternate layers of low-stress polycrystalline silicon (also referred to as a polysilicon) and a sacrificial material (e.g., silicon dioxide or a silicate glass). Vias etched through the sacrificial layers at predetermined locations provide anchor points to a substrate and mechanical and electrical interconnections between the polysilicon layers. Functional elements of the device are built up layer by layer using a series of deposition and patterning process steps. After the device structure is completed, it can be released for movement by removing the sacrificial material using a selective etchant such as hydrofluoric acid (HF) which does not substantially attack the polysilicon layers.

The result is a construction system generally consisting of a first layer of polysilicon which provides electrical interconnections and/or a voltage reference plane, and additional layers of mechanical polysilicon which can be used to form functional elements ranging from simple cantilevered beams to complex electromechanical drive or linkage systems. The entire structure is typically located in-plane with the substrate. As used herein, the term “in-plane” refers to a configuration generally parallel to the surface of the substrate and the terms “out-of-plane” refer to a configuration greater than zero degrees to about ninety degrees relative to the surface of the substrate.

Typical in-plane lateral dimensions of the functional elements can range from one micrometer to several hundred micrometers, while the layer thicknesses are typically about 0.5-2 micrometers. Because the entire process is based on standard IC fabrication technology, a large number of fully assembled MEMS devices can be batch-fabricated on a silicon substrate without any need for piece-part assembly.

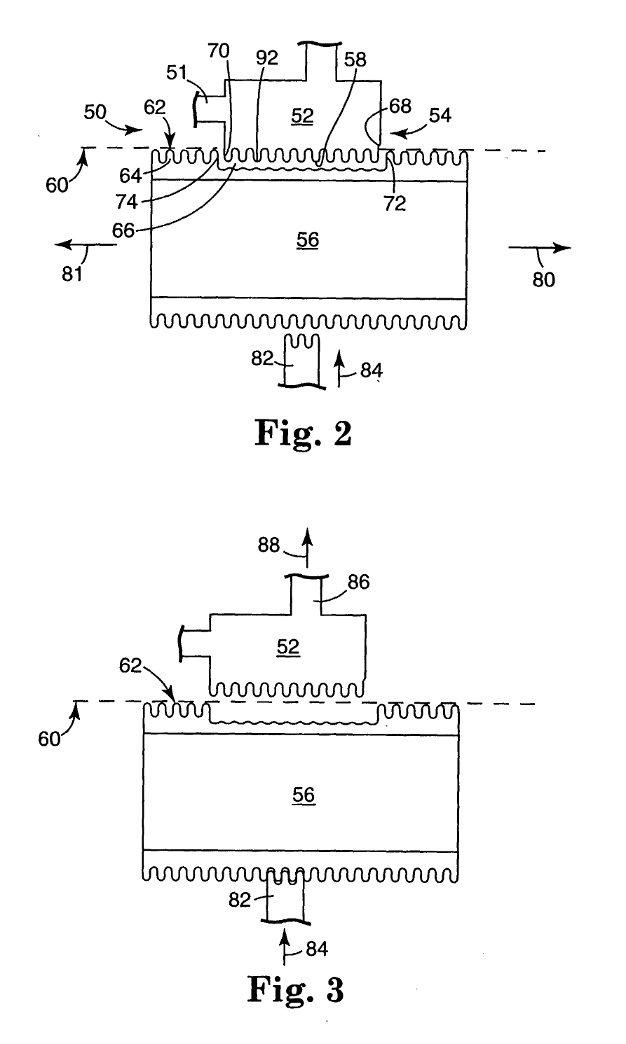

FIG. 2 is a top schematic view of a normally latched MEMS linear rack drive 50 in accordance with the present invention. As used herein, “normally latched” refers to a first discrete MEMS structure engaged with a second discrete MEMS structure without the use of actuators or other external force generating devices. Actuators or other external force generating devices are used to disengage the first discrete MEMS structure from the second discrete MEMS structure.

The MEMS rack drive 50 includes a drive 52 in a neutral position 54 releasably engaged with a driven portion 56. As used herein, “neutral position” refers to a position of a MEMS structures as fabricated. In the illustrated embodiment, the drive portion 56 is a rack. The drive 52 and the rack 56 are discrete MEMS structures that can move independently of each other. As used herein, “discrete MEMS structures” refers to two or more MEMS devices that can be engaged and disengaged.

The drive 52 is fabricated so that at least a portion of an operational surface 58 is positioned (i.e., in the neutral position) within an outer boundary 60 of operational surface 62 of the rack 56. As used here, “outer boundary” refers to a curve (or line) extending along and/or connecting the outer-most or largest features of an operational surface. In the illustrated embodiment, operational surface 62 is a plurality of teeth 64, while the outer boundary 60 is a line connecting the tops of the teeth 64. In some embodiments, the outer boundary 60 may extend past the physical limits of the operational surface (see FIG. 6).

Recess 66 that receives a portion of the drive 52 is located within the outer boundary 60 of the operational surface 62. As illustrated in FIG. 2, the drive 52 is engaged with the rack 56. As used herein, “engage” or “engaged” refer to an operational surface on a first discrete MEMS structure located in contact with, or within an outer boundary of, an operational surface on a second discrete MEMS structure. The first discrete MEMS structure may be in the neutral position or an operation position when engaged with the second discrete MEMS structure. As used herein, “disengage” or “disengaged” refer to an operational surface on a first discrete MEMS structure located outside an outer boundary of an operational surface on a second discrete MEMS structure.

The relative dimensions of the recess 66 and the operational surface 58 on the drive 52 are selected to satisfy the design rules for the MUMPS/MEMS process. Consequently, the drive 52 is a discrete MEMS structure that can be moved independently from the rack 56. Although the operational surfaces 58 and 62 are illustrated as having a plurality of mating teeth, a variety of other structures can be used, including square or triangular teeth, generally flat operational surface with rough or abrasive properties, and substantially flat operational surfaces (see e.g., FIG. 6) that rely primarily on friction, and/or combinations thereof. Rough or abrasive properties can be generated using the MUMPS/MEMS process or as a post-processing step. In some embodiments, the rough surface can be a bumpy, irregular, jagged, mottled and/or stippled surface.

The operational surface 58 is generally slightly smaller than the size of the recess 66. First and second edges 68, 70 of the operational surface 58 generally lies within edges 72, 74 of the recess 66. Consequently, the rack 56 is substantially prevented from moving, as fabricated, with the drive 52 in the neutral position 54.

The operation of the MEMS rack drive 50 is shown sequentially in FIGS. 2, 3, and 4. In operation, actuator 51 moves the drive 52 in a direction 81. The second edge 70 on the drive 52 presses against the edge 74 of the recess 66 causing the rack 56 to be displaced in the direction 81. Alternatively, actuator 51 moves the drive 52 in the direction 80. The first edge 68 of the drive 52 presses against the edge 72, causing the rack 56 to be displaced in the direction 80.

Power is applied to hold 82, causing it to move in the direction 84. As illustrated in FIG. 3, the hold 82 engages with the rack 56 to prevent further displacement. Actuator 86 moves the drive 52 in the direction 88, causing the operational surface 58 to disengage from the recess 66 on the rack 56. The amount of displacement generated by the actuator 86 must be sufficient to move the drive 52 outside the outer boundary 60 of the operational surface 62.

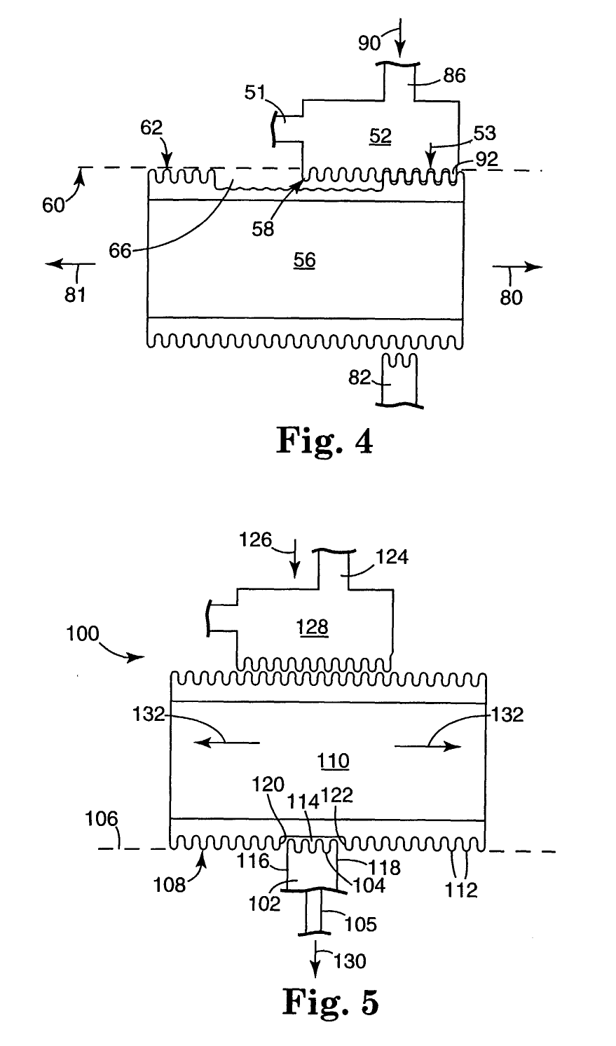

As illustrated in FIG. 4, power is removed from the actuator 51, causing the drive 52 to move in the direction 80. Power is then removed from the actuator 86, causing the drive 52 to move in the direction 90 and engage with the operational surface 62 on the rack 56. The operational surface 58 of the drive 52 is no longer in the recess 66. Since teeth 92 on the operational surface 58 are in contact with, or within the outer boundary 60 of the operational surface 62, the drive 52 is positively engaged with the rack 56. Power is then removed from the hold 82 so the hold 82 returns to its original position free of the rack 56, and the cycle starts over again. In some embodiments, the present normally latched drive 52 can obviate the hold 82.

In one embodiment, the drive 52 is in the neutral position 54 when engaged with the operational surface 62 on the rack 56. In another embodiment, depending upon the configuration of the respective operational surfaces 58, 62, the drive 52 may be slightly displaced from the neutral position 54 when engaged with the operational surface 62 on the rack 56, even though no actuators or other external force generating devices are acting on the drive 52. This displacement typically results in a slight biasing force 53 of the drive 52 on the operational surface 62 of the rack 56. This biasing force is the result of the resiliency of the material comprising the drive 52 and the actuator 51, not from the action of an actuator 51. As used herein, “operational position” refers to a slight displacement of a first discrete MEMS structure from the neutral position due to physical engagement with a second discrete MEMS structure. The operational position, like the neutral position, is maintained without the use of actuators or other external force generating devices.

FIG. 5 is a schematic illustration of a MEMS linear rack drive 100 with a normally latched hold 102. The hold 102 is fabricated so that at least a portion of an operational surface 104 is positioned (i.e., in the neutral position) within an outer boundary 106 of operational surface 108 of rack 10. In the illustrated embodiment, operational surface 108 is a plurality of teeth 112, while the outer boundary 106 is a line connecting the tops of the teeth 112. Recess 114 that receives a portion of the hold 102 is located within the outer boundary 106 of the operational surface 108. In other embodiments, operational surface 108 may be a variety of other structures such as square or triangular teeth, generally flat operational surface with rough or abrasive properties, or substantially flat operational surfaces that rely primarily on friction and/or combinations thereof.

The relative dimensions of the recess 114 and the operational surface 104 on the hold 102 are selected to satisfy the design rules for the MEMS process. Consequently, the hold 102 is a discrete MEMS structure that can be moved independently from the rack 110. The operational surface 104 is preferably generally the same size as the recess 114. First and second edges 116, 118 of the operational surface 104 generally lie within edges 120, 122 of the recess 114. Consequently, the rack 110 is substantially prevented from moving, as fabricated, with the hold 102 in the neutral position.

When power is not applied, the hold 102 engages the operational surface 108 of the rack 110. In operation, actuator 124 moves in direction 126, causing drive 128 to engage the rack 110. Power is then applied to actuator 105 connected to the hold 102, causing the hold 102 to move in the direction 130 and disengage from the rack 110. Power is applied to actuator 124 causing drive 128 to move in either direction along the axis 132, displacing the rack 110 along axis 132. Power is then removed from the actuator 105 on hold 102, permitting it to return to its normally latched position, engaged with the rack 110. Power is then removed from actuator 124 causing drive 128 to disengage from rack 10. Power is then released from actuator 124 allowing the drive 128 to move along the axis 132 to its original position. Power is removed from the actuator 124 so that the drive 128 disengages with the rack 110, and the cycle starts over again.

In one embodiment, the hold 102 is in the neutral position when engaged with the operational surface 108 on the rack 110. In another embodiment, depending upon the configuration of the respective operational surfaces 104, 108, the hold 102 may be slightly displaced from the neutral position when engaged with the operational surface 108 on the rack 110, even though no actuators or other external force generating devices are acting on the hold 102. This displacement causes the hold 102 to be biased against the operational surface 108. This biasing force is typically the result of the resiliency of the material comprising the hold 102 and the actuator 105.

FIG. 6 is a schematic illustration of a MEMS rotary rack drive 150 with a normally latched drive 152. Rack 154 rotates around pivot 156. Outer boundary 158 extends along operational surface 160 and beyond edge 162 of the rack 154. In the neutral position 164 illustrated in FIG. 6, a portion of operational surface 166 on the drive 152 is positioned within the outer boundary 158 of the rack 154. In the illustrated embodiment, the operational surface 160 is illustrated as being generally smooth. In an alternate embodiment, the operational surface 160 can include a variety of features that increase the friction with the operational surface 166 on the drive 152, such as, for example, teeth (see FIG. 2).

Edge 168 of the drive 152 lies within leading edge 162 of the rack 154, preventing it from rotating in the direction 170. The minimum gap between edge 162 of the rack 154 and the edge 168 of the drive 152 is limited by the design rules for the MUMPS process. In an alternate embodiment, the operational surface 160 could include a recess for receiving the drive 152 in the neutral position, as illustrated generally in FIGS. 2-5. In the illustrated embodiment, structure 172 is located at the opposite edge 174 of the rack 154 to prevent rotation in the direction 176.

In operation, actuator 178 moves the drive 152 in direction 180. The actuator 178 must displace the drive 152 outside of the outer boundary 158 of the rack 154. Actuator 179 then displaces the drive 152 in the direction 182 so that the operational surface 166 overlaps with the operational surface 160 on the rack 154. In another embodiment, the structure 172 is an actuator that displaces the rack 154 in the direction 170 to increase the overlap between the drive 152 and the rack 154.

The actuator 178 is then deactivated so that the operational surface 166 of the drive 152 engages with the operational surface 160 of the rack 154. Depending upon the structure of the operational surfaces 160, 166, the drive 152 may return to the neutral position 164 or an operational position. In either event, the normally latched drive 152 is engaged with the rack 154 without the use of actuators or other external force generating devices.

The rack 154 can now be rotated around pivot 156 by removing the force on actuator 179 so that the drive 152 moves in the opposite direction of 182. Hold 184 can optionally be used to retain the rack 154 in a particular location, while the actuator 178 disengages the drive 152 from the rack 154. Once disengaged, the drive 152 is moved in the direction 182 (or opposite 182). The actuator 178 is then deactivated so that the drive 152 engages the rack 154. The hold 184 is disengaged from the rack 154 and the cycle begins again.

In another embodiment, the hold 184 is normally latched, such as illustrated in FIG. 5. In yet another embodiment, both the hold 184 and the drive 152 are normally latched.

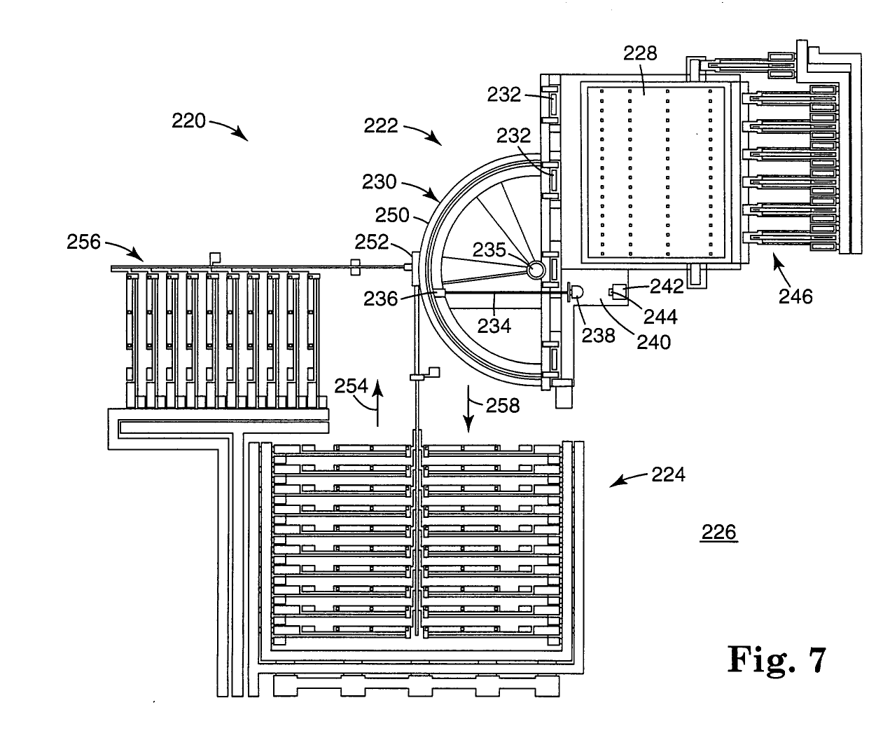

FIG. 7 is a top view of an exemplary MEMS device 220 that includes a normally latched drive 252. The MEMS device 220 includes a rotating mirror assembly 222 and two arrays of thermal actuators 224, 256 constructed on a surface of a substrate 226. The rotating mirror assembly 222 includes a mirror 228 attached to a rotating base 230 by one or more hinges 232. The rotating base 230 is attached to the surface of the substrate 226 by a pivot 235 that permits the mirror 228 and the base 230 to rotate. Latch arm 234 is attached to the rotating base 230 at first end 236. Free end 238 rests on portion 240 attached to the mirror 228.

The rotating mirror assembly 222 is formed in-plane on the surface of the substrate 226. After fabrication is completed, the mirror 228 is lifted out-of-plane. In the preferred embodiment, the mirror 228 is raised to a substantially vertical position relative to the surface of the substrate 226. As the mirror 228 is raised, free end 238 of the latch arm 234 slides along the surface 240 until it engages with latch hole 242. The latch hole 242 preferably includes a notch 244 that engages with free end 238 of the latch arm 234. Once engaged, the latch arm 234 retains the mirror 228 in the upright position. In an embodiment where an optical signal travels parallel to the surface of the substrate 226, the mirror 228 is generally perpendicular (vertical) to the substrate 226.

The mirror 228 can be raised manually or by a series of actuators. In the illustrated embodiment, an array of thermal actuators 246 is positioned to raise the mirror 228 off the surface of the substrate 226. Once in the partially raised configuration, the mirror 228 can be manually raised to the upright position.

The rotating base 230 includes an operational surface 250 that is engaged with a normally latched drive 252. In order to rotate the mirror 228 in the clockwise direction, the array of thermal actuators 224 are then activated so as to displace the normally latched drive 252 in the direction 254. The thermal actuators 256 are then activated to disengage the drive 252 from the rotating base 230. The thermal actuators 224 are then deactivated so that the drive 252 moves in the direction 258. The array 256 is then deactivated to engage the drive 252 with the rotating base 230 and the process of activating the array 224 is repeated. To rotate the mirror 228 in the counter-clockwise direction, the above noted process is reversed.

Other rotating micro-mirror designs are disclosed in Butler et al., “Scanning and Rotating Micromirrors Using Thermal Actuators”, v. 3131, SPIE, pp. 134-144 (1997); and in commonly assigned U.S. patent applications entitled “Optical Switch Based On Rotating Vertical Micro-Mirror”, filed Jan. 29, 2001, application Ser. No. 09/771,757; “MEMS-Based Polarization Mode Dispersion Compensator”, filed Jan. 29, 2001, application Ser. No. 09/771,765; and “MEMS-Based Wavelength Equalizer”, filed Oct. 31, 2000, application Ser. No. 09/702,591.

Various thermal actuator structures can be used with the present normally latched MEMS structures, such as disclosed in commonly assigned U.S. patent applications entitled “Direct Acting Vertical Thermal Actuator”, filed Sep. 12, 2000, application Ser. No. 09/659,572; “Direct Acting Vertical Thermal Actuator with Controlled Bending”, filed Sep. 12, 2000, application Ser. No. 09/659,798; and “Combination Horizontal and Vertical Thermal Actuator”, filed Sep. 12, 2000, application Ser. No. 09/659,282.

All of the patents and patent applications disclosed herein, including those set forth in the Background of the Invention, are hereby incorporated by reference. Although specific embodiments of this invention have been shown and described herein, it is to be understood that these embodiments are merely illustrative of the many possible specific arrangements that can be devised in application of the principles of the invention. Numerous and varied other arrangements can be devised in accordance with these principles by those of ordinary skill in the art without departing from the scope and spirit of the invention.

What is claimed is:

1. A normally latched MEMS device comprising:
a first discrete MEMS structure comprising an operational surface having an outer boundary;
a second discrete MEMS structure in a neutral position comprising an operational surface engaged with the first discrete MEMS structure; and
an actuator adapted to displace the second discrete MEMS structure from the engaged position to a disengaged position outside of the outer boundary of the first discreet MEMS structure.

2. The normally latched MEMS device of claim 1 comprising a second actuator adapted to displace the second discrete MEMS structure from engagement with the first discrete MEMS structure.

3. The normally latched MEMS device of claim 1 comprising a second actuator adapted to displace the first discrete MEMS structure from engagement with the second discrete MEMS structure.

4. The normally latched MEMS device of claim 1 wherein the first discrete MEMS structure comprises a linear rack.

5. The normally latched MEMS device of claim 1 wherein the first discrete MEMS structure comprises a rotary rack.

6. The normally latched MEMS device of claim 1 wherein the operational surface on the first discrete MEMS structure comprises a recess sized to receive the operational surface of the second discrete MEMS structure when the second discrete MEMS structure is in the neutral position.

7. The normally latched MEMS device of claim 1 wherein the operational surface of the second discrete MEMS device lies within an edge of the operational surface of the first discrete MEMS device when in the neutral position.

8. The normally latched MEMS device of claim 1 wherein the second discrete MEMS structure generates a biasing force against the first discrete MEMS structure when in the engaged configuration.

9. The normally latched MEMS device of claim 1 wherein the second discrete MEMS structure is displaced from the neutral position to an operational position when engaged with a portion of the operational surface on the first discrete MEMS structure.

10. The normally latched MEMS device of claim 1 wherein the second discrete MEMS structure generates a biasing force against the first discrete MEMS structure when in the operational position.

11. The normally latched MEMS device of claim 1 wherein the operational surface comprises a plurality of teeth.

12. The normally latched MEMS device of claim 1 wherein the operational surface comprises a generally smooth surface.

13. The normally latched MEMS device of claim 1 wherein the operational surface comprises a generally rough surface.

14. The normally latched MEMS device of claim 1 comprising at least one optical device.

15. The normally latched MEMS device of claim 14 wherein the optical device comprises one of a reflector, a lens, a polarizer, a wave guide, a shutter, or an occluding structure.

16. The normally latched MEMS device of claim 14 comprising an optical communication system including at least one optical device.

17. The normally latched MEMS device of claim 1 comprising at least one optical device coupled to the normally latched MEMS device.

18. A normally latched MEMS device comprising:
a first discrete MEMS structure comprising an operational surface having an outer boundary;
a second discrete MEMS structure in an operational position comprising an operational surface engaged with the first discrete MEMS structure; and
an actuator adapted to displace the second discrete MEMS structure from the engaged position to a disengaged position outside of the outer boundary.

19. A method of making a normally latched MEMS device comprising the steps of:
preparing a first discrete MEMS structure with an operational surface having an outer boundary;
preparing a second discrete MEMS structure in a neutral position having an operational surface engaged with the first discrete MEMS structure; and
preparing an actuator adapted to displace the second discrete MEMS structure from the engaged position to a disengaged position outside of the outer boundary.

20. The method of claim 19 comprising preparing a second actuator adapted to displace the second discrete MEMS structure from engagement with the first discrete MEMS structure.

21. The method of claim 19 comprising preparing a second actuator adapted to displace the first discrete MEMS structure from engagement with the second discrete MEMS structure.

22. The method of claim 19 comprising preparing a recess on the operational surface on the first discrete MEMS structure sized to receive the operational surface of the second discrete MEMS structure when the second discrete MEMS structure is in the neutral position.

23. The method of claim 19 comprising preparing the operational surface of the second discrete MEMS device so that it lies within an edge of the operational surface of the first discrete MEMS device when in the neutral position.

24. The method of claim 19 comprising preparing the second discrete MEMS structure to generate a biasing force against the first discrete MEMS structure when in the engaged configuration.

25. The method of claim 19 comprising displacing the second discrete MEMS structure to an operational position to engage with a portion of the operational surface on the first discrete MEMS structure.

26. The method of claim 19 comprising arranging the second discrete MEMS structure to generate a biasing force against the first discrete MEMS structure when in the operational position.

27. The method of claim 19 comprising preparing a plurality of teeth on the operational surface.

28. The method of claim 19 comprising preparing a generally smooth operational surface.

29. The method of claim 19 comprising preparing a generally rough operational surface.

30. The method of claim 19 comprising coupling at least one optical device to the normally latched MEMS device.

31. The method of claim 30 wherein the optical device comprises one of a reflector, a lens, a polarizer, a wave guide, a shutter, or an occluding structure.

32. The method of claim 30 comprising an optical communication system including at least one optical device.
